(19) United States
(12) Patent Application Publication
(10) Pub. No.: US 2013/0123392 A1
(43) Pub. Date: May 16, 2013

(54) HYDRAULIC COMPOSITION

(71) Applicants: Liam Guise, Sermerieu (FR); Serge Sabio, Saint Just Chaleyssin (FR); Hélène Lombois-Burger, Lyon (FR); Lilian Ferreint, Mions (FR)

(72) Inventors: Liam Guise, Sermerieu (FR); Serge Sabio, Saint Just Chaleyssin (FR); Hélène Lombois-Burger, Lyon (FR); Lilian Ferreint, Mions (FR)

(73) Assignee: LAFARGE, Paris (FR)

(21) Appl. No.: 13/805,712

(22) PCT Filed: Jun. 23, 2011
(86) PCT No.: PCT/FR11/51450

§ 371 Date: Jan. 30, 2013

(30) Foreign Application Priority Data
Jun. 24, 2010 (FR) 1055064

(51) Int. Cl. C04B 7/02

(52) U.S. Cl. CPC C04B 7/02
USPC 524/3; 524/5

(57) ABSTRACT

A hydraulic composition including

from 220 to 500 kg per cubic metre of fresh hydraulic composition, of a hydraulic binder including Portland cement;

from 400 to 1200 kg per cubic metre of the fresh hydraulic composition, of a sand having a D10 greater than 0.1 mm and a D90 less than 6 mm;

from 0.1 to 5 % by mass of dry extract relative to the mass of the hydraulic binder of a retarding agent;

from 0.05 to 5 % by mass of dry extract relative to the mass of the hydraulic binder of a superplasticizer; and

from 0.01 to 2% by mass of dry extract relative to the mass of the hydraulic binder of a rheology-modifying agent.

The invention relates to a hydraulic composition comprising a hydraulic binder and a retarding mix.

A retarding mix for a hydraulic composition is to be understood as a mix comprising a retarding agent, which induces a delay of the setting of the hydraulic composition, in particular a concrete. The beginning of the transition of the hydraulic composition from the plastic state to the stiff state is then retarded.

Generally, the setting delay of a hydraulic composition depends on the quantity of set-retarding agent added during the production of the hydraulic composition. Therefore, the quantity of added set-retarding agent is determined according to the desired moment when the hydraulic composition will be used and this quantity therefore varies from one application to another.

It would nevertheless be desirable to have a hydraulic composition, in particular a concrete, the setting of which would be retarded by more than a dozen hours, even several days, whatever the application envisaged. During this time, when the hydraulic composition has to be used, the setting of the hydraulic composition could be triggered at any moment, for example using an accelerating agent. The hydraulic composition could thus be advantageously stored for more than a dozen hours, even several days after its production and only be used at the desired time.

However, a hydraulic composition, in particular a concrete, begins to lose its rheology, then gels before the beginning of the setting, so that the time during which the hydraulic composition may be used, or workability window, is always shorter than the time separating the production of the hydraulic composition from the beginning of the setting. The workability of a hydraulic composition is generally determined by a slump or spread measurement of the hydraulic composition. The workability window corresponds then to the time during which the slump or spread of the hydraulic composition remains above a threshold, determined in particular according to the type of the hydraulic composition and to the given application.

Therefore, the problem that the invention intends to solve is to provide a hydraulic composition, comprising a hydraulic binder, retarded by more than a dozen hours, even several days, the workability window of which is more than a dozen hours, even several days without a triggering action.

With this aim, the present invention relates to a hydraulic composition comprising:
from 220 to 500 kg, per cubic metre of the fresh hydraulic composition, of a hydraulic binder comprising Portland cement;
from 400 to 1200 kg, per cubic metre of the fresh hydraulic composition, of a sand having a D10 greater than 0.1 mm and a D90 less than 4 mm;
from 0.1 to 5% by mass of dry extract relative to the mass of the hydraulic binder, of a retarding agent comprising a carboxylic acid, a phosphonic acid or salts thereof;
from 0.05 to 5% by mass of dry extract relative to the mass of the hydraulic binder, of a superplasticizer comprising a polyphosphate polyoxyalkylene polymer, a polyphosphonate polyoxyalkylene polymer, a polysulfonate polyoxyalkylene polymer or a polycarboxylate polyoxyalkylene polymer;
from 0.01 to 2% by mass of dry extract relative to the mass of the hydraulic binder, of a rheology-modifying agent comprising at least one compound selected from a viscosity-modifying agent, a water-retainer, a yield point modifier or a thixotropic agent,

resulting in that the setting time of the hydraulic composition is greater than or equal to 12 hours without triggering the setting process of the hydraulic composition and the variation of the slump of the hydraulic composition, measured according to the EN 12350-2 Standard, is less than 50 mm, or the variation of the spread of the hydraulic composition, measured with a cone according to the EN 12350-2 Standard, is less than 100 mm for at least 12 hours, preferably for at least one day, more preferably for at least two days, most preferably at least three days, without triggering the setting of the hydraulic composition.

The spread is measured for the fluid concretes and the slump is measured for the other concretes. When the slump of the hydraulic composition is too high to carry out a measurement according to the EN 12350-2 Standard, the spread of the hydraulic composition is measured using the same cone as the one used in a typical manner to measure the slump according to the EN 12350-2 Standard.

The invention offers at least one of the advantages described herein after.

Advantageously, the set-retarding duration of the hydraulic composition may be adapted in a simple manner according to the specifications.

The invention offers another advantage in that variations of the rheology of the hydraulic composition are reduced during the workability window of the hydraulic composition.

The invention offers another advantage in that the beginning of the setting occurs rapidly, in particular less than 36 hours after the end of the workability window of the hydraulic composition.

The invention offers another advantage in that after the beginning of the setting, the compressive strength of the hydraulic composition increases rapidly.

The invention offers another advantage in that the triggering of the retarded hydraulic composition may be initiated at any moment for several days by an intentional action of the user.

The invention offers another advantage in that any segregation phenomena of the hydraulic composition are avoided during the workability window of the hydraulic composition. The fresh hydraulic composition may then advantageously be transported and/or stored without mixing the hydraulic composition.

Finally, the invention has the advantage of being able to be used in one of the industries, for example the building industry, the chemical industry (admixture suppliers) and the cement industry.

Other advantages and characteristics of the invention will clearly appear after reading the following description and examples provided purely for illustrative and non-limiting purposes.

The expression <<hydraulic binder>> is to be understood according to the present invention as a pulverulent material, which, mixed with water, forms a paste which sets and hardens as a result of reactions, and which, after hardening, retains its strength and its stability, even under water. The hydraulic binder may be a cement according to the EN 197-1 Standard.

The expression <<hydraulic composition>>, is to be understood according to the present invention as a mix of a hydraulic binder, with mixing water, aggregates, optionally admixtures, and optionally mineral additions. A hydraulic composition may for example be concrete, in particular high performance concrete, very high performance concrete, self-placing concrete, self-levelling concrete, self-compacting concrete, fibre concrete, ready-mix concrete, lightweight concrete, pre-cast concrete or coloured concrete. The term <<concrete>>, is to be understood for example as concretes having been submitted to a finishing operation, for example bush-hammered concrete, exposed or washed concrete or polished concrete. Pre-stressed concrete is also to be understood by this definition. The term <<concrete>> comprises mortars, in this specific case concrete comprises a mix of a hydraulic binder, sand, water and optionally admixtures and optionally mineral additions. The term <<concrete>> according to the present invention denotes without distinction fresh concrete or hardened concrete. The hydraulic composition according to the present invention may be used directly on the jobsite in the fresh state and poured into a formwork adapted to the given application, or it may be used in precast applications, or as a jointing compound on a solid support.

The term <<aggregates>> is to be understood according to the present invention as gravel, coarse aggregates and/or sand.

The expression <<mineral additions>> is to be understood according to the present invention as a finely divided mineral material used in concrete in order to improve certain properties or to give it particular properties. Examples of mineral additions are fly ash (as defined in the EN 450 Standard), silica fume (as defined in the prEN 13263 Standard: 1998 or the NF P 18-502 Standard), slag (as defined in the NF P 18-506 Standard), limestone additions (as defined in the NF P 18-508 Standard) and siliceous additions (as defined in the NF P 18-509 Standard).

The expression <<Portland cement>> is to be understood according to the present invention as a cement of type CEM I, OEM II, CEM III, CEM IV or CEM V according to the NF EN 197-1<<Cement>> Standard.

The term <<clays>>, is to be understood according to the present invention as aluminium silicates and/or magnesium silicates, in particular phyllosilicates with a layer structure, typically spaced from approximately 7 to approximately 14 Angströms. Clays frequently found in sands may in particular be montmorillonite, illite, kaolinite, muscovite and chlorites. The clays may be of type 2:1 but also of type 1:1 (kaolinite) or 2:1:1 (chlorites).

The expression <<plasticizer/water-reducer>>, is to be understood according to the present invention as an admixture which, without modifying the consistency, makes it possible to reduce the water content of a given concrete, or which, without modifying the water content, increases the slump/spread of the concrete, or produces the two effects at the same time. The EN 934-2 Standard specifies that the water reduction should be greater than 5%. The water-reducers may, for example, have a base of lignosulfonic acids, carboxylic acids or treated carbon hydrates.

The expression <<superplasticizer>> or <<superfluidizer>> or <<super water-reducer>>, is to be understood according to the present invention as a plasticizer/water-reducer which makes it possible to reduce by more than 12% the quantity of water required to produce a concrete. A superplasticizer has a fluidizing action, since, for a same amount of water, the workability of the concrete increases when the superplasticizer is present.

The term <<setting>>, is to be understood according to the present invention as the passage to the solid state by chemical hydration reaction of a hydraulic binder. The setting is generally followed by the hardening period.

The term <<hardening>>, is to be understood according to the present invention as the increase of mechanical strengths of a hydraulic binder, after the end of the setting phase.

In the next part of the description, the terms retarding agent, superplasticizer and rheology-modifying agent are used to characterize functions of chemical compounds. It is clear that a same chemical compound may comprise several different functions. For example, a chemical compound may play both the role of a retarding agent and of a superplasticizer. For example, a chemical compound may play both the role of a retarding agent and of a rheology-modifying agent.

Retarding Agent

The retarding agent corresponds to the definition of the setting retarder described in the NF EN 934-2 Standard.

According to an embodiment of the invention, the retarding agent comprises a compound selected from:
carboxylic acids or salts thereof, in particular gluconic acid, gluconate, tartric acid, citric acid, gallic acid, glucoheptonic acid, saccharic acid and salicylic acid;
phosphonic acids and salts thereof, in particular aminotri(methylenephosphonic) acid, pentasodic salt of aminotri(methylenephosphonic) acid, hexamethylene-diamine-tetra(methylene-phosphonic) acid, diethylene-triamine-penta(methylene-phosphonic acid and its sodium salt); and
mixtures of these compounds.

The associated salts comprise, for example, ammonium salt, alkali metal salt (for example sodium salt, potassium salt, etc.), alkali earth metal salt (for example calcium salt, magnesium salt, etc.). However, other salts may also be used.

Preferably, the retarding agent comprises a hydroxycarboxylic acid or a salt of hydroxycarboxylic acid. According to an embodiment of the invention, the retarding agent comprises a gluconate.

Superplasticizer

According to an embodiment of the invention, the superplasticizer comprises a polymer comprising a main chain and more than three pendant chains linked to the main chain.

The superplasticizer comprises a polyphosphate polyoxyalkylene polymer, a polyphosphonate polyoxyalkylene polymer, a polysulfonate polyoxyalkylene polymer or a polycarboxylate polyoxyalkylene polymer (also called polycarboxylate polyox or PCP). Preferably, the superplasticizer comprises a polycarboxylate polyoxyalkylene polymer.

An example of a superplasticizer corresponds to a copolymer comprising at least one unit of formula (I)

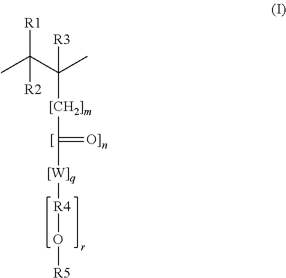

and at least one unit of formula (II)

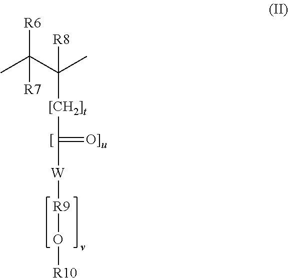

in which R1, R2, R3, R6, R7 and R8 are independently a hydrogen atom, a linear or branched C₁ to C₂₀ alkyl radical, or an aromatic radical, or a —COOR11 radical with R11 independently representing a hydrogen atom, a linear or branched C₁ to C₄ alkyl radical, a monovalent, divalent or trivalent cation or an ammonium group;

R10 is a hydrogen atom, a linear or branched C₁ to C₂₀ alkyl radical, or an aromatic radical;

R4 and R9 are independently a linear or branched C₂ to C₂₀ alkyl radical;

R5 is a hydrogen atom, a C₁ to C₂₀ alkyl group or an anionic or cationic group, for example a phosphonate group, a sulfonate group, a carboxylate group, etc;

W is an oxygen or nitrogen atom or an NH radical;

m and t are independently integers comprised from 0 to 2;

n and u are independently integers equal to 0 or 1;

q is an integer equal to 0 or 1;

r and v are independently integers comprised from 0 to 500;

and the molar mass of the said copolymer is comprised from 10 000 to 400 000 daltons.

Preferably, the radical R1 or R6 is a hydrogen atom. Preferably, the radical R2 or R7 is a hydrogen atom. Preferably, the radical R3 or R8 is a methyl radical or hydrogen atom. Preferably, the radical R4 or R9 is an ethyl radical.

Preferably, the copolymer used according to the invention or a salt thereof has an integer r from 1 to 300, preferably from 20 to 250, more preferably from 40 to 200, most preferably from 40 to 150.

The superplasticizer may correspond to a salt of the previously defined copolymer.

The copolymer may comprise one or more different units according to formula (I), in particular having different R5 radicals.

The superplasticizer may be a superplasticizer with immediate efficiency, the maximum fluidizing action being obtained within the first fifteen minutes at 20° C. after the addition of water to the hydraulic binder for conventional dosages. The superplasticizer may be a superplasticizer with differed efficiency, the maximum fluidizing action being obtained after the first fifteen minutes at 20° C. after the addition of water to the hydraulic binder for conventional dosages. The measurement of the fluidizing action of the superplasticizer with immediate efficiency and of the superplasticizer with differed efficiency is measured by a spread and/or slump measurement.

The increase of the fluidizing action of the superplasticizer with differed efficiency may be obtained by an increase of the capacity, of the superplasticizer with differed efficiency, to be adsorbed on the mineral components (in particular the particles of cement) of the hydraulic composition. With this aim, one possibility consists of increasing the density of anionic charges of the superplasticizer. An increase of the density of charges of the superplasticizer may be obtained by two different phenomena, which may occur simultaneously:
the increase of the number of charges carried by the polymer; and
the reduction of the molecular weight of the polymer.

The reduction of the molecular weight of the superplasticizer may be obtained by selecting a superplasticizer comprising a main chain and pendant chains linked to the main chain and which may separate from the main chain when the superplasticizer is in the hydraulic composition.

The separation of pendant chains and/or the increase of the number of charges carried by the superplasticizer may be obtained by selecting a superplasticizer comprising hydrolysable chemical functions, which, under the effect of hydroxide ions (OH⁻) in the hydraulic composition, may transform to provide carboxylate functions (COO⁻). The hydrolysable chemical functions are in particular anhydrides, esters and amides. A hydrolysable polymer is a polymer comprising hydrolysable chemical functions in basicity conditions and in the workability window of the hydraulic composition and a hydrolysable monomer is a monomer comprising a hydrolysable function in basicity conditions and in the workability window of the hydraulic composition.

An example of superplasticizer is the one described in the documents EP-A-537872, US20030127026 and US20040149174.

An example of superplasticizer is obtained by polymerisation of:
an ionic monomer of the phosphonic, sulfonic or carboxylic type, preferably the carboxylic type and advantageously the (meth)acrylic type; and
a monomer of the polyoxyalkylene glycol (from C₁ to C₄) (meth)acrylate type, for example of the polyethylene glycol (PEG) (meth)acrylate type, the molecular weight of which is for example from 100 to 10000, preferably from 500 to 5000 and advantageously from 750 to 2500.

The molar ratio between the unit according to formula (I) and the unit according to formula (II) may vary, for example from 90/10 to 45/55, preferably from 80/20 to 55/45.

It is possible to use one or more other monomer(s), for example those selected from:

(a) the acrylamide type, for example N,N-dimethylacrylamide, 2,2′-dimethylamino (meth)acrylate or salts thereof, 2,2′-dimethylaminoalkyl (meth)acrylate or salts thereof with the alkyl group and in particular ethyl and propyl, and generally any monomer comprising a function of the amine or amide type;

(b) the hydrophobic type, for example (meth)acrylate alkyl having 1 to 18 carbon atoms, in particular methyl or ethyl.

The quantity of this other monomer may vary from 5 to 25% mol of the total monomers.

In the case where the superplasticizer is a superplasticizer with a differed action, the anionicity of the superplasticizer may increase in the concrete within the workability window.

The superplasticizer may comprise a hydrolysable polymer in the concrete. During the production of the concrete, the pH being basic, hydrolysis reactions occur which result in a modification of the structure of the hydrolysable polymer and in a modification of the properties of the hydrolysable polymer, which is to say, an increase of the fluidizing action of the hydrolysable polymer. According to an embodiment of the invention, the hydrolysable polymer is a PCP.

Examples of superplasticizers with differed efficiency are described in the documents EP 1 136 508, WO 2007/047407, US 2009/0312460 and PCT/US2006/039991.

The form of the superplasticizer may vary from a liquid form to a solid form, via a wax form.

Rheology-Modifying Agent or RMA

The rheology-modifying agent comprises a compound selected from a viscosity-modifying agent, a water-retainer, a yield point modifier or a thixotropic agent. It is clear that the rheology-modifying agent may simultaneously have several functions of the agents described herein above.

A water-retaining agent may be as defined in the NF EN 934-2 Standard. Examples of water-retaining agents are cellulose ethers.

A viscosity-modifying agent is an agent which increases the viscosity of a hydraulic composition. An example of a representative measurement of the viscosity of a hydraulic composition corresponds to the measurement of the flow rate of the hydraulic composition to be tested through a device, for example the V-funnel. Examples of viscosity-modifying agents are cellulose ethers, natural or modified gums, in particular diutan, welan, xanthan, synthetic polymers, in particular polyacrylamides, polyacrylates, polyethylene oxides, natural or modified polymers, in particular starch, associated polymers, etc.

A yield point modifier is an admixture adapted to increase the yield point of the hydraulic composition. Examples of yield point modifiers are certain polysaccharides (diutan for example), certain clays, etc.

A thixotropic agent is a compound inducing a variation over time of the rheology (spontaneous structuring at rest, destructuring under shear). Examples of thixotropic agents comprise, in particular, clays.

Preferably, the rheology-modifying agent is water-soluble.

According to an embodiment of the invention, the rheology-modifying agent comprises a cellulose or a derivative of cellulose. According to an embodiment of the invention, the rheology-modifying agent comprises a cellulose ether. According to a variant of the invention, a cellulose ether used according to the invention is the methylhydroxypropyl cellulose. According to another variant of the invention, a cellulose ether used according to the invention is the methyl cellulose.

In the next part of the description, the mix comprising the retarding agent, the superplasticizer and the rheology-modifying agent is called the retarding mix.

Hydraulic Composition

The hydraulic binder comprises a Portland cement. Suitable cements comprise the Portland cements described in “Lea's Chemistry of Cement and Concrete>>. Portland cements include slag cements, pozzolan cements, fly ash cements, calcined shale cements, limestone cements and composite cements. It is for example a cement of type CEM I, CEM II, CEM III, CEM IV or CEM V according to the <<Cement>> NF EN 197-1 Standard. Preferably, the cement is of the type CEM I or CEM II.

The hydraulic composition comprises from 220 to 500 kg, preferably from 250 to 450 kg of the hydraulic binder per cubic metre of the fresh hydraulic composition.

The hydraulic composition comprises from 220 to 500 kg, preferably from 250 to 450 kg of Portland cement per cubic metre of the fresh hydraulic composition.

The hydraulic composition comprises from 400 to 1800 kg, preferably from 500 to 1600 kg, more preferably from 600 to 1100 kg of sand per cubic metre of the fresh hydraulic composition.

The sand has a D10 greater than 0.1 mm and a D90 less than 4 mm. The sand may be of any mineral, calcareous, siliceous or silica-calcareous or other nature. The sand may correspond to a mix of sands of different natures. The D90, also noted Dv90, corresponds to the 90^{th} percentile of the size distribution by volume of the particles. In other words, 90% of the particles have a size smaller than the D90 and 10% have a size larger than the D90. The D10, also noted D_{V}10, corresponds to the 10^{th} percentile of the size distribution by volume of the particles. In other words, 10% of the particles have a size smaller than the D10 and 90% have a size larger than the D10.

The composition may further comprise other aggregates, for example coarse aggregates, which correspond, for example, to aggregates having a particle size distribution comprised from 4 to 20 mm or to gravel which corresponds, for example, to aggregates having a particle size distribution strictly greater than 20 mm.

The hydraulic composition may further comprise from 5% to 40%, preferably from 10% to 30%, more preferably from 15% to 25%, by mass relative to the mass of the hydraulic binder of a particulate material (also called inorganic addition) or of a mix of particulate materials. The particulate material has, for example an average particle size less than 100 μm. The particulate material may comprise pozzolanic or non-pozzolanic materials or mixture thereof.

The term <<particle>> as used within the scope of the present invention is to be understood in the broad sense and corresponds not only to compact particles having a more or less spherical shape but also to angular particles, flattened particles, flake-shaped particles, fibre-shaped particles or fibrous particles, etc. The <<size>> of the particles within the scope of the present invention is to be understood as the smallest transverse dimension of the particles. By way of example, in the case of fibre-shaped particles, the size of the particles corresponds to the diameter of the fibres. Particles of a material are to be understood as particles taken individually (which is to say unitary elements of the material), knowing that the material may be in the form of agglomerates of particles. The term <<average size>>, is to be understood according to the present invention as the size of the particle which is larger than the size of 50% by volume of the particles and smaller than the size of 50% by volume of the particles of a distribution of particles.

An example of particulate material corresponds to slag, in particular to granulated blast furnace slag.

Suitable pozzolanic materials comprise silica fume, also known by the name of micro-silica, which is for example a by-product of the production of silicon or ferrosilicon alloys. It is known as a reactive pozzolanic material. Its main constituent is amorphous silicon dioxide. The individual particles generally have a diameter of approximately 5 to 10 nm. The individual particles may agglomerate to form aggregates of 0.1 to 1 μm. The 0.1 to 1 μm aggregates may agglomerate to form aggregates of 20 to 30 μm. Silica fume generally has a BET specific surface of 10-30 m²/g. The BET specific surfaces may be measured using a SA 3100 analyzer from Beckman Coulter with nitrogen as the adsorbed gas.

Other pozzolanic materials comprise fly ash, which generally has a D10 greater than 10 μm and a D90 less than 120 μm and has, for example a D50 from 30 to 50 μm. The D90, also noted D_{V}90, corresponds to the 90^{th} percentile of the size distribution by volume of the particles. In other words, 90% of the particles have a size smaller than the D90 and 10% have a size larger than the D90. The D50, also noted D_{V}50, corresponds to the 50^{th} percentile of the size distribution by volume of the particles. In other words, 50% of the particles have a size smaller than the D50 and 50% have a size larger than the D50. The D10, also noted D_{V}10, corresponds to the 10^{th} percentile of the size distribution by volume of the particles. In other words, 10% of the particles have a size smaller than the D10 and 90% have a size larger than the D10.

The average sizes and size distributions of the particles may be determined by laser granulometry (in particular using the laser Malvern MS2000 granulometer) for the particles with a size smaller than 63 μm, or by sieving for the particles with a size larger than 63 μm. However, when the individual particles tend to aggregate, it is preferable to determine their size by electronic microscopy, given that the apparent size, measured by laser diffraction granulometry, is then greater than the actual particulate size, which could distort the interpretation (agglomeration and flocculation).

The Blaine specific surface may be determined as described in the EN 196-6 Standard, paragraph 4.

Other pozzolanic materials comprise aluminosilicate-rich materials, for example metakaolin and natural pozzolans with volcanic, sedimentary, or diagenic origins.

Suitable non-pozzolanic materials comprise materials containing calcium carbonate (for example ground or precipitated calcium carbonate), preferably ground calcium carbonate. Ground calcium carbonate may, for example be Durcal® 1 (OMYA, France). The non-pozzolanic materials preferably have an average particle size smaller than 5 μm, for example from 1 to 4 μm. The non-pozzolanic materials may be a ground quartz, for example C800, which is a substantially non-pozzolanic filling material supplied by Sifraco, France. The preferred BET specific surface (determined by previously described known methods) of the calcium carbonate or ground quartz is from 2-10 m²/g, generally less than 8 m²/g, for example from 4 to 7 m²/g, preferably less than approximately 6 m²/g. Precipitated calcium carbonate is also suitable as a non-pozzolanic material. The individual particles generally have a (primary) size of the order of 20 nm. The individual particles agglomerate into aggregates having a (secondary) size of 0.1 to 1 μm. The aggregates having a (secondary) size of 0.1 to 1 μm may form aggregates themselves having a (ternary) size greater than 1 μm.

A single non-pozzolanic material or a mix of non-pozzolanic materials may be used, for example ground calcium carbonate, ground quartz or precipitated calcium carbonate or a mixture thereof. A mix of pozzolanic materials or a mix of pozzolanic and non-pozzolanic materials may also be used. According to an embodiment, the time between the end of the workability window of the hydraulic composition and the beginning of the setting of the hydraulic composition is less than 36 hours, preferably less than 24 hours, more preferably less than 16 hours.

According to an embodiment of the invention, the compressive strength of the hydraulic composition is at least equal to 1 MPa 24 hours after the beginning of the setting of the hydraulic composition.

The expression <<workability window>> of a hydraulic composition is to be understood according to the present invention as the time during which the slump of the hydraulic composition, measured according to the EN 12350-2 Standard, remains greater than or equal to 10 mm.

According to an embodiment of the invention, the quantity of retarding agent in the hydraulic composition is from 0.1 to 5% by mass of dry extract of the retarding agent relative to the mass of the dry hydraulic binder, preferably from 0.1 to 1.0% by mass of dry extract of the retarding agent relative to the mass of the dry hydraulic binder.

According to an embodiment of the invention, the quantity of superplasticizer in the hydraulic composition is from 0.05 to 5% by mass of dry extract of the superplasticizer relative to the mass of the dry hydraulic binder, preferably from 0.05 to 1% by mass of dry extract of the superplasticizer relative to the mass of the dry hydraulic binder, more preferably from 0.05 to 0.75% by mass of dry extract of the superplasticizer relative to the mass of the dry hydraulic binder, most preferably from 0.05 to 0.5% by mass of dry extract of the superplasticizer relative to the mass of the dry hydraulic binder.

According to an embodiment of the invention, the quantity of the rheology-modifying agent in the hydraulic composition is from 0.01 to 2% by mass of dry extract of the rheology-modifying agent relative to the mass of the dry hydraulic binder, preferably from 0.01 to 0.5% by mass of dry extract of the rheology-modifying agent relative to the mass of the dry hydraulic binder, more preferably from 0.025 to 0.4% by mass of dry extract of the rheology-modifying agent relative to the mass of the hydraulic binder.

The hydraulic binder may comprise Portland cement, according to the EN 197-1 Standard.

The final quantity of the retarding mix depends on the given properties, (for example the desired open time, concrete formula, etc).

The hydraulic composition is obtained by mixing aggregates, the hydraulic binder, the admixtures and water.

Generally, the mass ratio of effective water/dry binder (W/C ratio) may be comprised in general from 0.45 to 0.65.

The hydraulic composition may, in addition to the retarding mix, comprise other types of admixtures commonly-used in concretes.

Examples of admixtures which may be used are anti-foam agents, corrosion inhibitors, shrinkage-reducing agents, fibres, pigments, pumping aids, alkali reaction reducers, reinforcement agents, water-proofing compounds and mixtures thereof.

According to an embodiment of the invention, the hydraulic composition further comprises a clay-inerting agent, which is to say an admixture making it possible to at least partially neutralize the harmful effects due to the presence of clay in a hydraulic composition, in particular a hydraulic composition comprising a superplasticizer.

Process of Production

According to an embodiment of the invention, certain admixtures of the retarding mix may be directly introduced in the form of powder in the various constituents of the hydraulic composition whatever their physical states (liquid or solid form).

According to an embodiment of the invention, certain admixtures of the retarding mix may also be introduced in the form of a liquid or semi-liquid solution in the mixing water.

The retarding agent, the superplasticizer and the rheology-modifying agent may be added separately during the production of the hydraulic composition. A mix of the retarding agent, the superplasticizer and the rheology-modifying agent may nonetheless be carried out beforehand, the mix being then directly added to the hydraulic composition.

Advantageously, the variation of the slump of the hydraulic composition, measured according to the EN 12350-2 Standard, is less than 50 mm or the variation of the spread of the hydraulic composition, measured with a cone according to the EN 12350-2 Standard, is less than 100 mm for at least 12 hours, preferably for at least one day, more preferably for at least two days, most preferably at least three days, without triggering the setting of the hydraulic composition. Preferably, the consistency of the hydraulic composition is maintained in the same consistency class relative to the slump, as defined by the EN 206-1 Standard, for at least 12 hours, preferably for at least one day, more preferably for at least two days, most preferably at least three days, without triggering the setting of the hydraulic composition. This means that, if just after the production of the hydraulic composition, the consistency class of the hydraulic composition is, for example S4, then the consistency class of the hydraulic composition remains the S4 class for at least 12 hours, preferably for at least one day, more preferably for at least two days, most preferably at least three days, without triggering the setting of the hydraulic composition.

The process may further comprise the step of transporting and/or storing the fresh hydraulic composition, without mixing the hydraulic composition. The rheology-modifying agent makes it possible to advantageously maintain the homogeneity of the hydraulic composition even without mixing. Advantageously, the retarded hydraulic composition according to the invention, once produced, does therefore not require being mixed until it is used, which is to say, until triggering the setting of the hydraulic composition, which may occur naturally or be provoked. The hydraulic composition may therefore be transported and/or stored in bags, barrels or in any type of container without mixing the hydraulic composition. Preferably, the retarded hydraulic composition according to the invention is stored in closed packing, for example in a hermetically-sealed container. By way of example, the hydraulic composition may be transported in bags of the size of the order of a cubic metre. According to an embodiment, the retarded fresh hydraulic composition may be transported and/or stored, without mixing the hydraulic composition, for at least 12 hours, preferably for at least one day, more preferably for at least two days, most preferably at least three days. The hydraulic composition may be stored outdoors at temperatures varying from 5° C. to 30° C. Even at temperatures below 10° C., the variation of the slump of the hydraulic composition, measured according to the EN 12350-2 Standard, is less than 50 mm or the variation of the spread of the hydraulic composition, measured with a cone according to the EN 12350-2 Standard, is less than 100 mm for at least 12 hours, preferably for at least one day, more preferably for at least two days, most preferably at least three days, without triggering the setting of the hydraulic composition.

The fact that the hydraulic composition further comprises a rheology-modifying agent makes it possible to avoid any bleeding phenomena (rising of water to the surface of the concrete), sedimentation phenomena (greater concentration of aggregates at the base of the concrete) or consolidation phenomena (absence of paste at the level of the intergranular contact zones). These phenomena can degrade the visual aspect of the concrete and/or interfere, even practically prevent any re-handling of the concrete (in particular re-mixing it and using it), even though the hydraulic composition is not mixed during its transport and/or its storage.

The process may further comprise the transport and/or storage of the fresh hydraulic composition, preferably whilst mixing the hydraulic composition, for example in a drum truck.

The triggering of the setting of the hydraulic composition may be carried out by any means. The setting may be obtained without any particular action after the end of the workability window. The triggering of the setting of the hydraulic composition may be obtained by a physical, mechanical or chemical action, in particular by mixing, pumping, acoustic-wave mixing of the hydraulic composition.

Examples illustrate the invention without limiting its scope.

### EXAMPLES

The products and materials used in the examples are available from the following suppliers:

| | Product or material | Supplier |
|---|---|---|
| (1) | Portland Cement CEM I | Lafarge - Saint Pierre La Cour |
| | | or Le Havre |
| (2) | BL 200 ™ filling material | Omya |
| (3) | 0/5 mm sand | Saint Bonnet, France |
| (4) | 5/10 mm coarse aggregates | Saint Bonnet, France |
| (5) | CHRYSOPlast CER ™ admixture | Chryso |
| (6) | GLENIUM 27 ™ admixture | BASF |
| (7) | Rheotec Z60 ™ admixture | BASF |
| (8) | Culminal MHPC | Aqualon - Ashland |
| | 20000 P ™ admixture | |
| (9) | PRELOM 300 ™ admixture | BASF |
| (10) | Tylose MHS 3000000P6 admixture | SE Tylose |
| (11) | Fly ash | Thermal power plant Carling |
| | | (France) |
| (12) | Limestone filling material | Lafarge - Saint Pierre La Cour |
| (13) | Portland cement CEM II 32.5 | Lafarge - Saint Pierre La Cour |
| (14) | Portland cement CEM II 42.5 | Lafarge - Saint Pierre La Cour |

The cement CEM I was the cement produced by Lafarge coming from the site of Saint Pierre La Cour or the site of Le Havre which was of the type CEM 152.5 N according to the EN 197-1 Standard.

The cement CEM II 32.5 was the cement produced by Lafarge coming from the site of Saint Pierre La Cour which was of the type CEM II 32.5 N according to the EN 197-1 Standard.

The cement OEM II 42.5 was the cement produced by Lafarge coming from the site of Saint Pierre La Cour which was of the type CEM II 42.5 N according to the EN 197-1 Standard.

The BL 200™ filling material was a limestone mineral addition. It had a D90 less than 50 μm.

The 0/5 mm sand and the 5/10 mm coarse aggregates from Saint Bonnet were of the alluvial siliceous-calcareous type.

The CHRYSOPlast CER™ is generally commercialised as a fluidizer. It may nevertheless also have a retarding action. In the present examples, the CHRYSOPlast CER™ was called a retarding agent even though it also had a fluidizing action.

The GLENIUM 27™ admixture was a superplasticizer of the PCP type having immediate action.

The Rheotec Z60™ admixture was a superplasticizer having delayed action.

The Rheotec Z60™ superplasticizer was a PCP.

The PRELOM 300™ admixture was a superplasticizer having immediate action with a base of modified polycarboxylic ethers.

The Culminal MHPC 20000 P™ admixture was a rheology-modifying agent corresponding to a hydroxypropyl methyl cellulose.

The Tylose MHS 3000000P6 admixture was a rheology-modifying agent corresponding to a hydroxyethyl methyl cellulose.

The limestone filling material or limestone filler was produced by Lafarge on the site of Saint Pierre La Cour.

The fly ash came from the thermal power plant of Carling (France).

Mortar Formulation

The formulation (1) of concrete used to carry out the tests is described in the following table 1:

TABLE 1
Mortar Formulation (1)

| | Proportion (in g) |
|---|---|
| | for 1 L of fresh |
| Component | mortar |
| Lafarge Cement | 408 |
| Saint Pierre La Cour | |
| BL 200 ™ limestone filler | 72.9 |
| 0-5 Sand from Saint | 1502.4 |
| Bonnet | |
| Total water | 269.02 |
| Admixtures | See examples |

Concrete Formulations

The formulation (2) of concrete used to carry out the tests is described in the following table 2:

TABLE 2
Concrete Formulation (2)

| | Proportion (in kg) |
|---|---|
| | for 1 m³ of |
| Component | fresh concrete |
| Lafarge Cement | 280 |
| Saint Pierre La Cour | |
| BL 200 ™ limestone filler | 50 |
| 0-5 Sand from Saint Bonnet | 990 |
| 5-10 Coarse aggregates from | 830 |
| Saint Bonnet | |
| Total water | 200 |
| Admixtures | See examples |

The formulation (3) of concrete used to carry out the tests is described in the following table 3:

TABLE 3
Concrete Formulation (3)

| | Proportion (in kg) for |
|---|---|
| | 1 m³ of |
| Component | fresh concrete |
| Lafarge Cement | 280 |
| Le Havre | |
| BL 200 ™ limestone filler | 56 |
| 0-5 Sand from Saint Bonnet | 910 |
| 5-10 Coarse aggregates from | 487 |
| Saint Bonnet | |
| 10-20 Coarse aggregates from | 433 |
| Saint Bonnet | |
| Total water | 182 |
| Admixtures | See examples |

The formulation (4) of concrete used to carry out the tests is described in the following table 4:

TABLE 4
Concrete Formulation (4)

| | Proportion (in kg) |
|---|---|
| | for 1 m³ of |
| Component | fresh concrete |
| Lafarge Cement | 294 |
| Le Havre | |
| BL 200 ™ limestone filler | 56 |
| 0-5 Sand from Saint Bonnet | 977 |
| 5-10 Coarse aggregates from | 820 |
| Saint Bonnet | |
| Total water | 180 |
| Admixtures | See examples |

Preparation Method of a Mortar According to Formulation (1)
Put the sands in the vessel of a Perrier mixer;
At T=0 second: begin mixing at low speed (140 rpm) and simultaneously add the wetting water in 30 seconds, then continue to mix at low speed (140 rpm) until 60 seconds;
At T=60 seconds: stop the mixing and let rest for 4 minutes;
At T=5 minutes: (this time corresponds to T0 for the rheology retention test): add the cement, the mineral addition and the rheology-modifying agent and mix at low speed (140 rpm) for 1 minute;
At T=6 minutes: add the mixing water (+optional admixtures) in 30 seconds (whilst mixing at low speed (140 rpm));
At T=6 minutes and 30 seconds: mix for 1 minute at high speed (280 rpm).
At T=7 minutes and 30 seconds: stop the mixing.

Preparation Method of a Concrete According to Formulation (2), (3) or (4)
Put the sands and coarse aggregates in the vessel of a mixer of type Zyklos (capacity 30 or 50 L), Sipe (capacity 230 L) or Pemat (capacity 500 L);
At T=0 second: begin mixing and simultaneously add the wetting water in 30 seconds, then continue to mix until 60 seconds;
At T=60 seconds: stop the mixing and let rest for 4 minutes;
At T=5 minutes (this time corresponds to T0 for the rheology retention test): add the Portland cement, and the rheology-modifying agent and mix for 1 minute;
At T=6 minutes: add the mixing water (+optional admixtures) in 30 seconds whilst continuing to mix;
At T=6 minutes and 30 seconds: mix for 1 minute and 30 seconds;
At T=8 minutes: stop the mixing.

Measurement Method of the Spread of a Hydraulic Composition

The principle of the spread measurement consisted of filling a truncated spread measurement cone with the hydraulic composition to be tested, then releasing the said composition from the truncated spread measurement cone in order to determine the diameter of the disc obtained when the hydraulic composition had finished spreading. The truncated spread measurement cone corresponded to a reproduction at the scale ½ of the truncated cone as defined by the NF P 18-451 Standard, 1981. The truncated spread measurement cone had the following dimensions:
top diameter: 50 +/−0.5 mm;
bottom diameter: 100+/−0.5 mm; and
height: 150+/−0.5 mm.

The entire operation was carried out at 20° C. The spread measurement was carried out as described below:
Fill the reference truncated cone in one single operation with the hydraulic composition to be tested;
Homogenously distribute the hydraulic composition in the truncated cone;
Level the top surface of the cone;
Lift the truncated cone vertically; and
Measure the spread according to four diameters at 45° using a calliper square. The result of the spread measurement was the average of the four values +/−1 mm.

Measurement Method of the Slump of a Hydraulic Composition

The slump was measured as described in the EN 12350-2 Standard: <<Essai pour béton frais—Partie 2: Essai d′ affaissement>> [Tests for fresh concrete—Part 2 Slump test].

Measurement Method of the Compressive Strength

The compressive strength was measured for the mortars as described in the EN 196-1 Standard <<Méthode d′ essais des ciments>> [Cement test methods] and for the concretes as described in the EN 12390-2 Standard: <<Essai pour beton durci—Partie 2: Confection et conservation des éprouvettes pour essais de résistance>> [Test for hardened concrete—Part 2: Production and conservation of specimens for strength tests] and the PR EN 12390-3:1999 Standard: <<Essai pour béton durci—Partie 3: Résistance à la compression des éprouvettes>> [Test for hardened concrete—Part 3: Compressive strength of specimens] using cylindrical specimens with a diameter of 11 cm and height of 22 cm.

Measurement Method of the Setting Time of a Hydraulic Composition

A temperature recorder was used, for example a temperature recorder commercialised by Testo. The hydraulic composition was placed in an adiabatic enclosure. The recorder was placed in the hydraulic composition. The temperature was recorded every minute. The temperature of the hydraulic composition tended to drop after the production of the hydraulic composition, then it stabilised at a constant temperature plateau until setting, during which time the temperature increased temporarily. For the measurements carried out above 15° C., the beginning of the setting, unless otherwise specified, corresponded to the time duration measured from 24 hours after the production of the hydraulic composition until the moment when the temperature increased by two degrees relative to the temperature plateau for a hydraulic composition.

### Example 1

Five mortars M0, M1, M2, M3 and M4 were prepared according to formulation (1) at 20° C. A litre of each mortar M0, M1, M2, M3 and M4 was produced.

The retarding agent for the mortars M0, M1, M2 and M3 and M4, was CHRYSOPIast CER™. Each mortar M0, M1 and M2 comprised 0.35% by mass of dry extract of the retarding agent relative to the mass of cement.

The rheology-modifying agent for the mortars M0, M1, M2, M3 and M4, was Culminal MHPC 20000 P™. Each mortar M0, M1, M2, M3 and M4 comprised 0.11% by mass of dry extract of the rheology-modifying agent relative to the mass of cement.

The mortar M0 was the reference mortar and did not comprise a superplasticizer.

The superplasticizer for the mortar M1 was Rheotec Z60™, The mortar M1 comprised 0.4% by mass of dry extract of Rheotec Z60™ relative to the mass of cement.

The superplasticizer for the mortar M2 was GLENIUM 27™. The mortar M2 comprised 0.4% by mass of dry extract of GLENIUM 27™ relative to the mass of cement.

The superplasticizer for the mortar M3 was PRELOM 300™. The mortar M3 comprised 0.55% by mass of dry extract of PRELOM 300™ relative to the mass of cement.

The superplasticizer for the mortar M4 was a mix of GLENIUM 27™ and Rheotec Z60™. The mortar M4 comprised 0.15% by mass of dry extract of GLENIUM 27™ relative to the mass of cement and 0.15% by mass of dry extract of Rheotec Z60™ relative to the mass of cement.

The mortars M0, M1 and M2 were left to rest, without mixing. Three samples were kept for each mortar. Spread measurements were carried out, at 20° C., at 5 minutes for the first sample, at 24 hours for the second sample and at 48 hours for the third sample. Each sample was mixed shortly before the measurement. The results of these tests are grouped together in the following Table 5:

TABLE 5

| | Superplasticizer (% by | Spread | Spread | Spread |
|---|---|---|---|---|
| | mass of dry extract/mass | at 5 min | at 24 h | at 48 h |
| Mortar | of cement) | (mm) | (mm) | (mm) |
| M0 | — | 150 | 105 | 100 |
| M1 | Rheotec Z60 ™ - 0.4% | 160 | 205 | 155 |
| M2 | GLENIUM 27 ™ - 0.4% | 190 | 170 | 170 |
| M3 | PRELOM 300 ™ - 0.55% | 180 | 170 | 160 |
| M4 | GLENIUM 27 ™ - 0.15% | 170 | 165 | 150 |
| | Rheotec Z60 ™ - 0.15% | | | |

The decrease of the spread over 48 hours was approximately 50 mm for the mortar M0, which corresponded to a spread decrease over 0.48 hours, measured with a cone according to the EN 12350-2 Standard, greater than 100 mm. The mortar M0 was therefore not satisfactory.

The decrease of the spread over 48 hours was less than 20 mm for the mortars M1, M2, M3 and M4, which corresponded to a spread decrease over 48 hours, measured with a cone according to the EN 12350-2 Standard, less than 100 mm. The mortars M1, M2, M3 and M4 were therefore satisfactory. Furthermore, no bleeding or sedimentation was observed for the mortars M1, M2, M3 and M4.

### Example 2

Two concretes C1 and C2 were prepared according to formulation (2) at 20° C. For each concrete C1 and C2, approximately 20 litres of concrete were produced.

The retarding agent for the concretes C1 and C2 was CHRYSOPIast CER™. Each concrete C1 and C2 comprised 0.35% by mass of dry extract of the retarding agent relative to the mass of cement.

The rheology-modifying agent for the concretes C1 and C2 was Culminal MHPC 20000 P™. Each concrete C1 and C2 comprised 0.11% by mass of dry extract of the rheology-modifying agent relative to the mass of cement.

The superplasticizer for the concrete C1 was GLENIUM 27™. The concrete C1 comprised 0.4% by mass of dry extract of GLEN IUM 27™ relative to the mass of cement.

The superplasticizer for the concrete C2 was Rheotec Z60™. The concrete C2 comprised 0.4% by mass of dry extract of Rheotec Z60™ relative to the mass of cement.

Each concrete C1 and C2 was placed in a 25-litre pail. The pails were hermetically sealed with a cover, then attached to a pallet, which was transported by a power lift truck for 10 minutes, without mixing, at an average speed of a dozen kilometres per hour. The power lift truck did not comprise shock absorbers. The concretes C1 and C2 were then left to rest, without mixing.

Four samples were kept for each concrete. Slump measurements were carried out, at 20° C., at 5 minutes for the first sample, at 24 hours for the second sample and 48 hours for the third sample and at 72 hours for the fourth sample. Each sample was mixed shortly before the measurement. The results of these tests are grouped together in the following Table 6:

TABLE 6

| | Superplasticizer (% by | | | | |
|---|---|---|---|---|---|
| | mass of dry extract/mass | Slump (mm) | | | |
| Concrete | of cement) | 5 min | 24 h | 48 h | 72 h |
| C1 | GLENIUM 27 ™ (0.40%) | 240 | 230 | 220 | 170 |
| C2 | Rheotec Z60 ™ (0.40%) | 220 | 255 | 250 | 220 |

The variation of the slump over 48 hours was less than 50 mm for the concretes C1 and C2. The concretes C1 and C2 were therefore satisfactory. Moreover, the variation of the slump over 72 hours was less than 50 mm for the concrete C2. Furthermore, no bleeding or sedimentation was observed to a sensitive degree for the concretes C1 and C2, despite transportation without mixing.

The setting time was approximately 88 hours for the concretes C1 and C2. The length of time between the end of the workability window and the beginning of the setting of the concretes C1 and C2 was therefore less than 16 hours.

### Example 3

A concrete C3 was prepared according to formulation (2) at 20° C. Three batches of approximately 500 litres each were prepared. The retarding agent was CHRYSOPIast CER™. The concrete C3 comprised 0.35% by mass of dry extract of the retarding agent relative to the mass of cement.

The rheology-modifying agent was Culminal MHPC 20000 P™. The concrete C3 comprised 0.13% by mass of dry extract of the rheology-modifying agent relative to the mass of cement.

The superplasticizer was GLENIUM 27™. The concrete C3 comprised 0.40% by mass of dry extract of GLENIUM 27™ relative to the mass of cement.

The batches were produced in a mixer of the Pemat type. The three batches were homogenised by 70 revolutions in a 2-m³ Fiori mixer truck. Three waterproof bags P1, P2 and P3 with a double envelope were each filled with approximately 400 litres of the concrete C3.

The bags were transported by truck, without mixing, for 75 minutes, of which 15 minutes at an average speed of 110 km/h and 60 minutes at an average speed of 80 km/h.

The bags were then left to rest.

The slump was measured at 4 hours for the concrete C3 of the bag P1. The slump was measured at 24 hours for the concrete C3 of the bag P2, and the slump was measured at 48 hours for the concrete C3 of the bag P3. The concrete was mixed shortly before the measurement. The results of these tests are grouped together in the following Table 7:

TABLE 7

| Bag of | Slump | Measurement |
|---|---|---|
| concrete | (mm) | moment |
| P1 | 190 | 4 h |
| P2 | 185 | 24 h |
| P3 | 170 | 48 h |

The concrete C3 was kept in the same class of consistency (class S4) for 48 hours. No bleeding and no compaction of the aggregates were observed in each bag. The bags P1, P2 and P3 could be emptied without difficulty into the mixer truck. The concrete C3 flowed by itself without having to be vibrated. Furthermore, the bags P1, P2 and P3 were completely emptied without any remaining clusters of paste or aggregates on the sides of the bags.

### Example 4

A concrete C4 was prepared according to formulation (3) at 20° C. A batch of approximately 500 litres was prepared.

The retarding agent was CHRYSOPIast CER™. The concrete C4 comprised 0.3% by mass of dry extract of the retarding agent relative to the mass of cement.

The rheology-modifying agent was Culminal MHPC 20000 P™. The concrete C4 comprised 0.13% by mass of dry extract of the rheology-modifying agent relative to the mass of cement.

The superplasticizer was GLENIUM 27™. The concrete C4 comprised 0.3% by mass of dry extract of GLENIUM 27™ relative to the mass of cement.

The concrete was mixed in a mixer of the Pemat type and was homogenised by 70 revolutions in a 2-m³ Fiori mixer truck. A double-envelope bag was filled with approximately 400 litres of the concrete C4.

The bag was transported by truck without mixing. The bag was then left to rest.

Two samples were kept. Slump measurements were carried out, at 20° C., at 5 minutes for the first sample, and at 48 hours for the second sample. Each sample was mixed shortly before the measurement. The results of these tests are grouped together in the following Table 8:

TABLE 8

| | Slump at | Slump at |
|---|---|---|
| Concrete | 5 min (mm) | 48 h (mm) |
| C4 | 220 | 170 |

The variation of the slump of the concrete C4 was less than 50 mm over 48 hours. No bleeding and no compaction of the granular skeleton were observed after storage.

### Example 5

Two concretes C5 and C6 were prepared according to formulation (4) at 20° C. For each concrete C5 and C6, approximately 20 litres of concrete were produced.

The retarding agent for the concretes C5 and C6 was CHRYSOPIast CER™. Each concrete C5 and C6 comprised 0.3% by mass, expressed as dry extract, of the retarding agent relative to the mass of cement.

The superplasticizer for the concretes C5 and C6 was GLENIUM 27™. Each concrete C5 and C6 comprised 0.3% by mass, expressed as dry extract, of the rheology-modifying agent relative to the mass of cement.

The rheology-modifying agent for the concrete C5 was Culminal MHPC 20000 P™. The concrete C5 comprised 0.13% by mass, expressed as dry extract, of the rheology-modifying agent relative to the mass of cement.

The rheology-modifying agent for the concrete C6 was Tylose MHS 300000P6. The concrete C6 comprised 0.13% by mass, expressed as dry extract, of the rheology-modifying agent relative to the mass of cement.

Each concrete C1 and C2 was placed in a 25-litre pail. The pails were hermetically sealed with a cover, then attached to a pallet, which was transported by a power lift truck for 10 minutes, without mixing, at an average speed of a dozen kilometres per hour. The power lift truck did not comprise shock absorbers. The concretes C1 and C2 were then left to rest, without mixing.

Four samples were kept for each concrete. Slump measurements were carried out, at 20° C., at 5 minutes for the first sample, at 24 hours for the second sample, at 48 hours for the third sample and at 72 hours for the fourth sample. Each sample was mixed shortly before the measurement. The results of these tests are grouped together in the following Table 9:

TABLE 9

| | Rheology-modifying | | | |
|---|---|---|---|---|
| | agent (% by mass of dry | Slump (mm) | | |
| Concrete | extract/mass of cement) | 5 min | 24 h | 48 h |
| C5 | Culminal MHPC | 235 | 225 | 215 |
| | 20000 P ™ (0.13%) | | | |
| C6 | Tylose MHS | 240 | 230 | 220 |
| | 300000P6 (0.04%) | | | |

The variation of the slump over 48 hours was less than 50 mm for the concretes C5 and C6. The concretes C5 and C6 were therefore satisfactory. Furthermore, no bleeding or sedimentation was observed to a sensitive degree for the concretes C5 and C6, despite transportation without mixing.

### Example 6

A mortar M5 was prepared according to formulation (1) at 20° C. The cement was the cement produced by Lafarge coming from the site of Le Havre of the type CEM I 52.5 N according to the EN 197-1 Standard.

A mortar M6 was prepared according to formulation (1) at 20° C., the difference being that the cement of formulation (1) was replaced by 85% by mass of the OEM I 52.5 N cement type, according to the EN 197-1 Standard, produced by Lafarge coming from the site of Le Havre and 15% by mass of the limestone filling material from Saint Pierre La Cour.

A mortar M7 was prepared according to formulation (1) at 20° C., the difference being that the cement of formulation (1) was replaced by 85% by mass of the CEM I 52.5 N cement type, according to the EN 197-1 Standard, produced by Lafarge coming from the site of Le Havre and 15% by mass of fly ash coming from the Carling site.

A mortar M8 was prepared according to formulation (1) at 20° C., the difference being that the cement of formulation (1) was replaced by 85% by mass of the CEM I 32.5 N cement type, according to the EN 197-1 Standard, produced by Lafarge coming from the site of Saint Pierre la Cour and 15% by mass of the limestone filling material from Saint Pierre La Cour.

A mortar M9 was prepared according to formulation (1) at 20° C. the difference being that the cement of formulation (1) was replaced by 82% by mass of the CEM I 42.5 N cement type, according to the EN 197-1 Standard, produced by Lafarge coming from the site of Saint Pierre la Cour and 18% by mass of the limestone filling material from Saint Pierre la Cour.

A litre of each mortar M5, M6, M7, M8 and M9 was produced The retarding agent for the mortars M5, M6, M7, M8 and M9, was CHRYSOPIast CER™. Each mortar M5, M6 and M7 comprised 0.33% by mass, expressed in dry extract, of the retarding agent relative to the mass of binder (cement+substitution material). Each mortar M8 and M9 comprised 0.38% by mass, expressed in dry extract, of the retarding agent relative to the mass of binder (cement+substitution material).

The rheology-modifying agent for the mortars M5, M6, M7, M8 and M9, was Culminal MHPC 20000 P™. Each mortar M5, M6, M7, M8 and M9 comprised 0.11% by mass, expressed in dry extract, of the rheology-modifying agent relative to the mass of binder (cement+substitution material).

The superplasticizer for the mortars M5, M6, M7, M8 and M9, was GLENIUM 27™. Each mortar M5, M6 and M7 comprised 0.3% by mass, expressed in dry extract, of the superplasticizer relative to the mass of binder (cement+substitution material). The mortar M8 comprised 0.35% by mass, expressed in dry extract, of the superplasticizer relative to the mass of binder (cement+substitution material). The mortar M9 comprised 0.5% by mass, expressed in dry extract, of the superplasticizer relative to the mass of binder (cement+substitution material).

The mortars M5, M6, M7, M8 and M9 were left to rest, without mixing. Three samples were kept for each mortar. Spread measurements were carried out, at 20° C., at 5 minutes for the first sample, at 24 hours for the second sample and at 48 hours for the third sample. Each sample was mixed shortly before the measurement. The results of these tests are grouped together in the following Table 10:

TABLE 10

| | | | Spread | Spread | Spread |
|---|---|---|---|---|---|
| | | | at 5 min | at 24 h | at 48 h |
| Mortar | Cement | Addition | (mm) | (mm) | (mm) |
| M5 | CEM I (100%) | 0% | 165 | 165 | 150 |
| M6 | CEM I (85%) | Limestone filler | 165 | 150 | 150 |
| | | (15%) | | | |
| M7 | CEM I (85%) | Fly ash (15%) | 130 | 120 | 120 |
| M8 | CEM II 32.5 (74%) | Limestone filler | 155 | 135 | 135 |
| | | (26%) | | | |
| M9 | CEM II 42.5 (82%) | Fly ash (18%) | 155 | 155 | 135 |

The decrease of the spread over 48 hours was less than 20 mm for the mortars M5, M6, M7, M8 and M9, which corresponded to a decrease of the spread over 48 hours less than 100 mm, measured with a cone according to the EN 12350-2 Standard. The mortars M5, M6, M7, M8 and M9 were therefore satisfactory. Furthermore, no bleeding or sedimentation of the mortars M5, M6, M7, M8 and M9 was observed.

1. A hydraulic composition comprising:
from 220 to 500 kg, per cubic metre of fresh hydraulic composition, of a hydraulic binder comprising Portland cement;
from 400 to 1800 kg, per cubic metre of fresh hydraulic composition, of a sand having a D10 greater than 0.1 mm and a D90 less than 4 mm;
from 0.1 to 5% by mass of dry extract relative to the mass of hydraulic binder, of a retarding agent comprising a carboxylic acid, a phosphonic acid or salts thereof;
from 0.05 to 5% by mass of dry extract relative to the mass of hydraulic binder, of a superplasticizer comprising a polyphosphate polyoxyalkylene polymer, a polyphosphonate polyoxyalkylene polymer, a polysulfonate polyoxyalkylene polymer or a polycarboxylate polyoxyalkylene polymer, and
from 0.01 to 2% by mass of dry extract relative to the mass of hydraulic binder, of a rheology-modifying agent comprising at least one compound selected from a group consisting of a viscosity-modifying agent, a water-retainer, a yield point modifier or a thixotropic agent,
wherein a setting time of the hydraulic composition is greater than or equal to 12 hours without triggering the setting of the hydraulic composition and a variation of the slump of the hydraulic composition, measured according to the EN 12350-2 Standard, is less than 50 mm or thea variation of the spread of the hydraulic composition, measured with a cone according to the EN 12350-2 Standard, is less than 100 mm for at least 12 hours without triggering the setting of the hydraulic composition.

2. The hydraulic composition according to claim 1, wherein the retarding agent comprises a hydroxycarboxylic acid or a salt of hydroxycarboxylic acid.

3. The hydraulic composition according to claim 2, wherein the retarding agent comprises a gluconate.

4. The hydraulic composition according to claim 1, wherein the quantity of retarding agent is comprised from 0.1 to 1% by mass of dry extract relative to the mass of the hydraulic binder.

5. The hydraulic composition according to claim 1, wherein the quantity of the superplasticizer is comprised from 0.05 to 1% by mass of dry extract relative to the mass of the hydraulic binder.

6. The hydraulic composition according to claim 5, wherein the quantity of the superplasticizer is comprised from 0.05 to 0.5% by mass of dry extract relative to the mass of the hydraulic binder.

7. The hydraulic composition according to claim 1, wherein the quantity of the rheology-modifying agent is comprised from 0.025 to 0.4% by mass of dry extract relative to the mass of the hydraulic binder.

8. The hydraulic composition according to claim 1, wherein the superplasticizer comprises a polycarboxylate polyoxyalkylene polymer.

9. The hydraulic composition according to claim 1, wherein the rheology-modifying agent comprises cellulose or a derivative of cellulose.

10. The hydraulic composition according to claim 1, wherein a compressive strength of the hydraulic composition is at least equal to 1 MPa 24 hours after the beginning of the setting of the hydraulic composition.

11. The hydraulic composition according to claim 1, wherein a time duration between the end of the workability window of the hydraulic composition and the beginning of the setting of the hydraulic composition is less than 36 hours.

12. The hydraulic composition according to claim 11, wherein a time duration between the end of the workability window of the hydraulic composition and the beginning of the setting of the hydraulic composition is less than 24 hours.
